(19) United States
(12) Patent Application Publication
(10) Pub. No.: US 2021/0209133 A1
(43) Pub. Date: Jul. 8, 2021

(54) DATA PROCESSING METHOD AND MOBILE PLATFORM

(71) Applicant: SZ DJI TECHNOLOGY CO., LTD., Shenzhen (CN)

(72) Inventors: Yong CONG, Shenzhen (CN); Mo ZHOU, Shenzhen (CN); Qi ZHANG, Shenzhen (CN)

(21) Appl. No.: 17/209,188

(22) Filed: Mar. 22, 2021

Related U.S. Application Data
(63) Continuation of application No. PCT/CN2018/108454, filed on Sep. 28, 2018.

(51) Int. Cl. G06F 16/28; G06F 16/215

(52) U.S. Cl. CPC G06F 16/285; G06F 16/215

(57) ABSTRACT

A data processing method includes obtaining N sampled data items from a sensor of a mobile platform, and separating the N sampled data items into a first data group, a second data group, and a third data group. Each of the first data group and the second data group includes M sampled data items, and the third data group includes one sampled data items. M is an integer greater than or equal to 2, and N=2×M+1. The method further includes obtaining a median data item of the N sampled data items according to a larger one of a minimum sampled data item in the first data group and a minimum sampled data item in the second data group, a smaller one of a maximum sampled data item in the first data group and a maximum sampled data item in the second data group, and the one sampled data item in the third data group.

### CROSS-REFERENCE TO RELATED APPLICATION

This application is a continuation of International Application No. PCT/CN2018/108454, filed Sep. 28, 2018, the entire content of which is incorporated herein by reference.

### TECHNICAL FIELD

The present disclosure relates to the field of electronic technologies and, more particularly, to a data processing method and a mobile platform.

### BACKGROUND

As a flight platform, unmanned aerial vehicles can be equipped with a variety of external devices to accomplish required tasks. For example, unmanned aerial vehicles can be equipped with cameras for taking pictures, or unmanned aerial vehicles can be equipped with microphones for audio recording, or unmanned aerial vehicles can be equipped with environmental sensors for environmental monitoring. After an unmanned aerial vehicle collects data through these external devices, the unmanned aerial vehicle can perform operations such as correction, statistical error, or down-sampling, on the data. Because of the large amount of the collected data, generally, sampled data items are obtained from the collected data first, and then median filtering is performed on the sampled data items to obtain a median data item. Subsequently, operations including correction, statistical errors, or down-sampling are performed on the collected data according to the median data item.

In existing technologies, a bubble sort process is used to perform the median filtering on the sampled data items. A specific process includes: repeatedly visiting the sampled data item to be sorted, and comparing two adjacent sampled data items sequentially; if the order (such as from large to small, or from small to large) of the two adjacent sampled data items is wrong, exchanging the two adjacent sampled data items. This process is performed until all the sampled data items do not need to be exchanged, indicating that the sampled data items have been sorted. Then, it is determined that the centered sampled data item is the median data item for the sampled data items after the sorting is completed.

However, the above sorting process is complicated and affects the efficiency of median filter processing.

### SUMMARY

In accordance with the disclosure, there is provided a data processing method including obtaining N sampled data items from a sensor of a mobile platform, and separating the N sampled data items into a first data group, a second data group, and a third data group. Each of the first data group and the second data group includes M sampled data items, and the third data group includes one sampled data items. M is an integer greater than or equal to 2, and N=2×M+1. The method further includes obtaining a median data item of the N sampled data items according to a larger one of a minimum sampled data item in the first data group and a minimum sampled data item in the second data group, a smaller one of a maximum sampled data item in the first data group and a maximum sampled data item in the second data group, and the one sampled data item in the third data group.

Also in accordance with the disclosure, there is provided a mobile platform including a sensor and a processor configured to obtain N sampled data items from the sensor, and separate the N sampled data items into a first data group, a second data group, and a third data group. Each of the first data group and the second data group includes M sampled data items, and the third data group includes one sampled data items. M is an integer greater than or equal to 2, and N=2×M+1. The processor is further configured to obtain a median data item of the N sampled data items according to a larger one of a minimum sampled data item in the first data group and a minimum sampled data item in the second data group, a smaller one of a maximum sampled data item in the first data group and a maximum sampled data item in the second data group, and the one sampled data item in the third data group.

### BRIEF DESCRIPTION OF THE DRAWINGS

The above and/or additional aspects and advantages of this disclosure will become obvious and easy to understand from the description of the embodiments in conjunction with the following drawings.

FIG. 1 is an exemplary unmanned aerial vehicle consistent with various embodiments of the present disclosure.

FIG. 2 is an exemplary data processing method consistent with various embodiments of the present disclosure.

FIG. 3 is an exemplary data processing method with N=5 consistent with various embodiments of the present disclosure.

FIG. 4 is an exemplary data processing method with N=7 consistent with various embodiments of the present disclosure.

FIG. 5 is an exemplary method for obtaining N sampled data items consistent with various embodiments of the present disclosure.

FIG. 6 is an exemplary method for obtain the intermediate value sub data consistent with various embodiments of the present disclosure.

FIG. 7 is an exemplary mobile platform consistent with various embodiments of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” “front,” “back,” “lower,” “upper,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed. Further, “plurality of” means at least two.

The present disclosure provides a communication method, a system, and a mobile platform. The mobile platform may be an unmanned aerial vehicle, an unmanned boat, an unmanned automobile, or a robot. In one embodiment, the unmanned aerial vehicle may be a rotorcraft including a multi-rotor craft propelled by a plurality of air propulsion devices. The present disclosure has no limit on this.

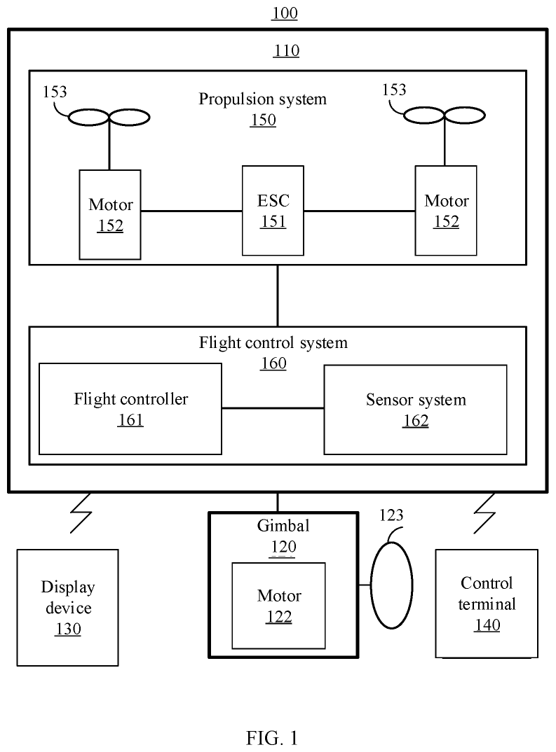

The present disclosure provides an unmanned aerial system. For description purposes only, embodiments where the unmanned aerial system is a rotor unmanned aerial vehicle will be used as examples to illustrate the present disclosure and do not limit the scopes of the present disclosure. FIG. 1 illustrates an unmanned aerial system.

As illustrated in FIG. 1, in one embodiment, the unmanned aerial system 100 includes an unmanned aerial vehicle 110, a gimbal 120, a display device 130, and a control terminal 140. The unmanned aerial vehicle 110 includes a propulsion system 150, a flight control system 160, and a vehicle frame. The unmanned aerial vehicle 110 can communicate with the control terminal 140 and the display device 130 in a wireless manner.

The vehicle frame may include a vehicle body and a support (also referred to as landing gear). The vehicle frame may include a center frame and one or more arms connected to the center frame. The one or more arms may extend radially from the center frame. The support may be connected to the vehicle body and used to support the unmanned aerial vehicle 110 when it lands.

The propulsion system 150 includes one or more electronic speed controls (ESCs) 151, one or more propellers 153, and one or more motors 152 corresponding to the one or more propellers 153. Each of the one or more motors 152 may be connected between a corresponding one of the one or more electronic speed controls 151 and a corresponding one of the one or more propellers 153. The one or more motors 152 and the one or more propellers 153 may be arranged at the one or more arms of the unmanned aerial vehicle 110. The one or more electronic speed controls 151 may be configured to receive a driving signal generated by the flight control system 160 and provide driving current to the one or more motors 152 according to the driving signal to control the speed of the one or more motors 152. The one or more motors 152 may be configured to drive the one or more propellers 153 to rotate, thereby providing propulsion for the flight of the unmanned aerial vehicle 110, and the propulsion may enable the unmanned aerial vehicle 110 to achieve one or more degrees of freedom of movement. In some embodiments, the UAV 110 may rotate about one or more rotation axes. For example, the one or more rotation axes may include a roll axis, a yaw axis, or a pitch axis. It should be understood that the one or more motors 152 may be DC motors or AC motors. In addition, the one or more motors 152 may be brushless motors or brushed motors.

The flight control system 160 includes a flight controller 161 and a sensing system 162. The sensing system 162 may be used to measure attitude information of the unmanned aerial vehicle, that is, position information, or status information of the unmanned aerial vehicle 110 in space, such as three-dimensional position, three-dimensional angle, three-dimensional velocity, three-dimensional acceleration, or three-dimensional angular velocity. The sensing system 162 may include, for example, at least one of sensors such as a gyroscope, an ultrasonic sensor, an electronic compass, an inertial measurement unit (IMU), a vision sensor, a global navigation satellite system, or a barometer. For example, in one embodiment, the global navigation satellite system may be a global positioning system (GPS). The flight controller 161 may be used to control the flight of the unmanned aerial vehicle 110. For example, the flight of the unmanned aerial vehicle 110 can be controlled according to the attitude information measured by the sensor system 162. It should be understood that the flight controller 161 can control the UAV 110 according to pre-programmed program instructions, and can also control the UAV 110 by responding to one or more control instructions from the control terminal 140.

The gimbal 120 may include a motor 122. The gimbal 120 may be used to carry an imaging device 123 or a microphone (not shown in the figure). The flight controller 161 may control the movement of the gimbal 120 through the motor 122. Optionally, in another embodiment, the gimbal 120 may further include a controller for controlling the movement of the gimbal 120 by controlling the motor 122. It should be understood that the gimbal 120 may be independent of the unmanned aerial vehicle 110 or may be a part of the unmanned aerial vehicle 110. It should be understood that the motor 122 may be a DC motor or an AC motor. In addition, the motor 122 may be a brushless motor or a brushed motor. It should also be understood that the gimbal may be located at the top of the unmanned aerial vehicle or at the bottom of the unmanned aerial vehicle.

The imaging device 123 may be, for example, a device for capturing images, such as a camera or a video recorder, and the imaging device 123 may communicate with the flight controller and take pictures under the control of the flight controller. The imaging device 123 of this embodiment may at least include a photosensitive element, and the photosensitive element may be, for example, a complementary metal oxide semiconductor (CMOS) sensor or a charge-coupled device (CCD) sensor.

The display device 130 may be located on the ground end of the unmanned aerial system 100, and may communicate with the unmanned aerial vehicle 110 in a wireless manner. The display device 130 may be used to display the attitude information of the unmanned aerial vehicle 110. In addition, the image taken by the imaging device may also be displayed on the display device 130. It should be understood that the display device 130 may be an independent device or integrated in the control terminal 140.

The control terminal 140 may be located on the ground end of the unmanned aerial system 100, and can communicate with the unmanned aerial vehicle 110 in a wireless manner for remote control of the unmanned aerial vehicle 110.

It should be understood that the aforementioned naming of the components of the unmanned aerial system is only for identification purposes, and should not be understood as a limitation to the embodiments of the present disclosure. It should be noted that the unmanned aerial vehicle may include all or some of the above-mentioned components in various embodiments.

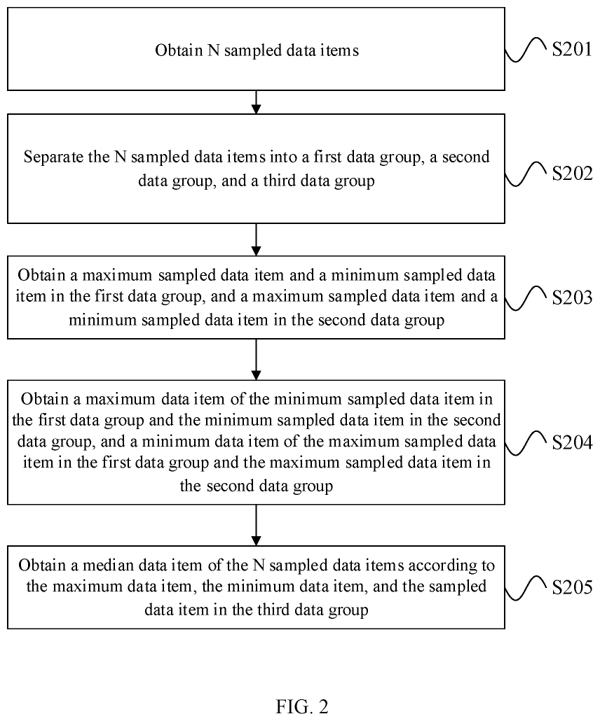

The present disclosure also provides a data processing method. FIG. 2 shows an exemplary data process method provided by one embodiment of the present disclosure. The data processing method may include S201-S205, and may be applied to a mobile platform.

At S201 of the data processing method, N sampled data items are obtained. The sampled data items may be sensor data items output by a sensor of the mobile platform.

In one embodiment, the N sampled data items may be obtained and N may be an integer larger than or equal to 5. For example, N may be equal to 5 or equal to 7. The sampled data items may be the sensor data items output by the sensor of the mobile platform.

Optionally, the sensor data items may be: image data items, audio data items, magnetic field strength, temperature, humidity, position information, displacement, attitude angles, acceleration, and/or velocity.

The sensor may be an image sensor (for example, an imaging device), and the sampled data items may be the image data items; or, the sensor may be a sound sensor (for example, a microphone), and the sampled data items may be the audio data items; or, the sensor may be a magnetic sensor, and the sampled data items may be the magnetic field strength; or, the sensor may be a temperature sensor, and the sampled data items may be the temperature; or, the sensor may be a humidity sensor, and the sampled data items may be the humidity; or, the sensor may be an acceleration sensor, and the sampled data items may be the acceleration; or, the sensor may be a velocity sensor, and the sampled data items may be the velocity; or, the sensor may be a displacement sensor, and the sampled data items may be the displacement; or, the sensor may be an attitude sensor, and the sampled data items may be the attitude angles.

At S202 of the data processing method, the N sampled data items are separated into a first data group, a second data group, and a third data group.

In the present embodiment, the N sampled data items may be separated into three data groups including the first data group, the second data group, and the third data group. The number of sampled data items included in the first data group and the number of sampled data items included in the second data group may be the same, e.g., each of the first data group and the second data group may include M sampled data item, where M is an integer larger than or equal to 2. The third data group may include one sampled data item. Therefore, N=2×M+1.

Which data item of the N sampled data items is included in the first data group, the second data group, and the third data group may be random, which is not limited in the present disclosure. In some embodiments, the 1st to Mth sampled data items among the N sampled data items may be regarded as the first data group, the (M+1)-th to (2M)-th sampled data items as the second data group, and the last sampled data item as the third data group.

At S203, a maximum sampled data item and a minimum sampled data item in the first data group, and a maximum sampled data item and a minimum sampled data item in the second data group are obtained. In this disclosure, a maximum sampled data item and a minimum sampled data item in a data group are also referred to as “group maximum sampled data item” and “group minimum sampled data item,” respectively. For example, the maximum sampled data item and the minimum sampled data item in the first data group are also referred to as “first-group maximum sampled data item” and “first-group minimum sampled data item,” respectively, and similarly for the second data group, as well as the third to eleventh data groups.

In the present embodiment, the sampled data items in the first data group may be sorted to obtain the maximum sampled data item (such as MAX1) and the minimum sampled data item (such as MIN1) in the first data group. The sampled data items in the second data group may be sorted to obtain the maximum sampled data item (such as MAX2) and the minimum sampled data item (such as MIN2) in the second data group.

Optionally, in one embodiment, the maximum sampled data item may be the last sampled data item after sorting according to a preset order, and the minimum sampled data item may be the first sampled data item after sorting according to the preset order. Optionally, the preset order may be an ascending order.

Optionally, in another embodiment, the maximum sampled data item may be the first sampled data item after sorting according to a preset order, and the minimum sampled data item may be the last sampled data item after sorting according to the preset order. Optionally, the preset order may be a descending order.

At S204, a maximum data item between the minimum sampled data item in the first data group and the minimum sampled data item in the second data group, and a minimum data item between the maximum sampled data item in the first data group and the maximum sampled data item in the second data group may be obtained.

In the present embodiment, the minimum sampled data item in the first data group and the minimum sampled data item in the second data group may be compared to each other to obtain the maximum data item (such as MAX) of these data items. The maximum sampled data item in the first data group and the maximum sampled data item in the second data group may be compared to each other to obtain the minimum data item (such as MIN) of these data items.

At S205, according to the maximum data item, the minimum data item, and the sampled data item in the third data group, a median data item of the N sampled data items is obtained.

In the present embodiment, after the maximum data item and the minimum data item are obtained, the median data item of the N sampled data items may be obtained according to the maximum data item, the minimum data item, and the sampled data item in the third data group. Optionally, after the median data item is obtained, operations including correction, statistical error, down-sampling may be performed on the captured data according to the median data item. The present disclosure has no limit on this.

In one embodiment, S205 may be achieved by: determining a median data item of the maximum data item, the minimum data item, and the sampled data item in the third data group, according to the maximum data item, the minimum data item, and the sampled data item in the third data group; and using the median data item of the maximum data item, the minimum data item, and the sampled data item in the third data group as the median data item of the N sampled data items.

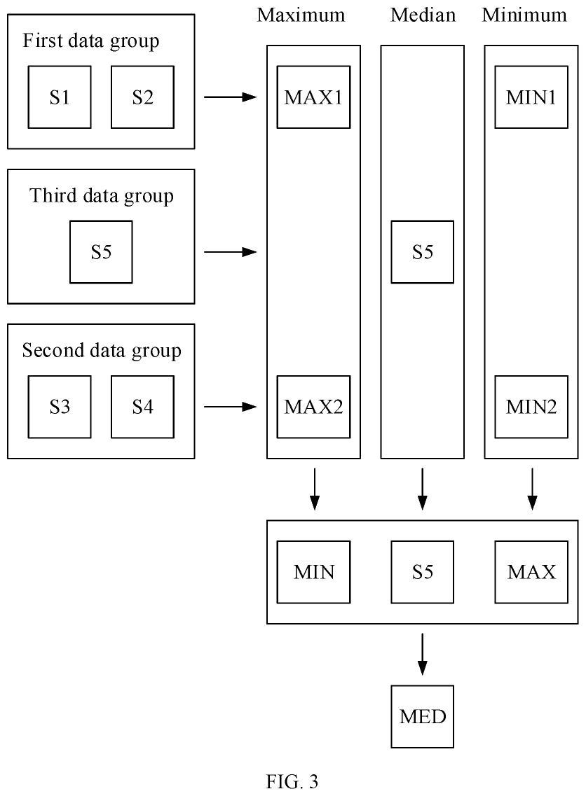

For description purposes only, one embodiment with N=5 will be used to illustrate the present disclosure and does not limit the scope of the present disclosure. As illustrated in FIG. 3, in one embodiment with N=5, the first data group includes sampled data items S1 and S2, the second data group includes sampled data items S3 and S4, and the third data group includes a sampled data item S5. The maximum data item of S1 and S2 may be determined to be MAX1, and the minimum data item of S1 and S2 may be determined to be MIN1. The maximum data item of S3 and S4 may be determined to be MAX2, and the minimum data item of S3 and S4 may be determined to be MIN2. The minimum data item of MAX1 and MAX2 may be determined to be MIN, and the maximum data item of MIN1 and MIN2 may be determined to be MAX. The median data item of MAX, MIN, and S5 may be determined to be MED which is one of MAX, MIN and S5. Finally, MED may be determined to be the median data item of the N sampled data items.

For example, the first data group is 1 and 2, the second data group is 3 and 4, and the third data group is 5. The maximum sampled data item of the first data group is 2, and the minimum sampled data item of the first data group is 1. The maximum sampled data item of the second data group is 4, and the minimum sampled data item of the second data group is 3. The minimum data item of 2 and 4 is 2 by comparing 2 to 4, and the maximum data item of 1 and 3 is 3 by comparing 1 to 3. Subsequently, the median data item is determined to be 3 by comparing 2, 3 and 5. Finally, 3 is determined to be the median data item of 1 to 5.

In some other embodiments, S205 may be achieved by: determining a median data item of a median data item of the first data group, a median data item of the second data group, and the sampled data item in the third data group, from the median data item of the first data group, the median data item of the second data group, and the sampled data item in the third data group; and determining a median data item of the maximum data item, the minimum data item, and the median data item of the median data item of the first data group, the median data item of the second data group, and the sampled data item in the third data group, as the median data item of the N sampled data items.

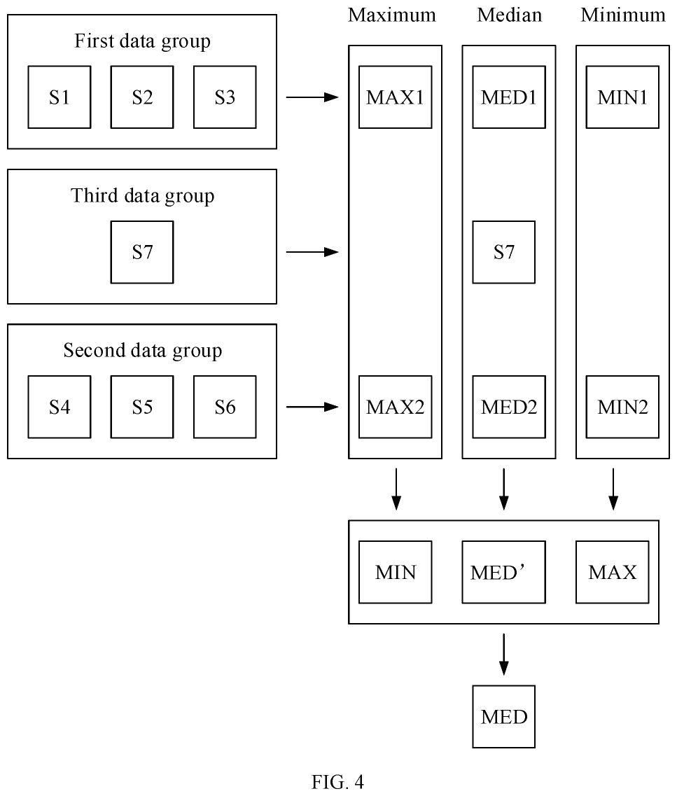

For description purposes only, one embodiment with N=7 will be used to illustrate the present disclosure and does not limit the scope of the present disclosure. As illustrated in FIG. 4, in one embodiment with N=7, the first data group includes sampled data items S1, S2, and S3. The second data group includes sampled data items S4, S5, and S6. The third data group includes a sampled data item S7. In S1, S2, and S3, the maximum data item may be determined to be MAX1, the median data item may be determined to be MED1, and the minimum data item may be determined to be MIN1. In S4, S5, and S6, the maximum data item may be determined to be MAX2, the median data item may be determined to be MED2, and the minimum data item may be determined to be MIN2. The minimum data item of MAX1 and MAX2 may be determined to be MIN, and the maximum data item of MIN1 and MIN2 may be determined to be MAX. The median data item of MED1, MED2, and S7 may be determined to be MED′. The median data item of MAX, MIN, and MED′ may be determined to be MED which is one of MAX, MIN and MED′. Finally, MED may be determined to be the median data item of the N sampled data items.

For example, the first data group includes 1, 2 and 3, the second data group includes 4, 5, and 6, and the third data group is 7. The maximum data item of the first data group is 3, and the minimum data item of the first data group is 1. The maximum data item of the second data group is 6, and the minimum data of the second data group is 4. The minimum data item of 3 and 6 is 3 by comparing 3 to 6, and the maximum data item of 1 and 4 is 4 by comparing 1 to 4. Subsequently, the median data item of 2, 5, 7 is determined to be 5 by comparing 2, 5 and 7. Finally, the median data item of 3, 4, 5 is determined to be 4 by comparing 3, 4, 5, and 4 is determined to be the median data item of 1 to 7.

In the present disclosure, the N sampled data items may be separated into a data group including one sampled data item and two other data groups each of which includes at least two sampled data items. The maximum sampled data items and the minimum sampled data items may be determined from the other two data groups. Then the median data item of the N sampled data items may be determined according to the minimum data item of the maximum sampled data items of the other two data groups, the maximum data items of the minimum sampled data items of the other two data groups, and the one sampled data items of the third data group. The acquisition of the median data item may be simple, and the efficiency of the media filter process.

In some embodiments, S201 may be achieved by: obtaining L sampled data items; and obtaining the N sampled data items by removing G sampled data items from the L sampled data items. L may be an integer equal to G+N.

In one embodiment, N may be 5 and L may be 6. Correspondingly, 6 sampled data items may be obtained. Then one sampled data item of the 6 sampled data items may be removed from the 6 sampled data items to obtain 5 sampled data items.

In another embodiment, N may be 7 and L may be 8. Correspondingly, 8 sampled data items may be obtained. Then one sampled data item of the 8 sampled data items may be removed from the 8 sampled data items to obtain 7 sampled data items.

In another embodiment, N may be 7 and L may be 9. Correspondingly, 9 sampled data items may be obtained. Then two sampled data items of the 9 sampled data items may be removed from the 9 sampled data items to obtain 7 sampled data items.

For description purposes only, the embodiment where one sampled data item is removed from the L sampled data items will be used an example to illustrate the present disclosure and does not limit the scope of the present disclosure. In one embodiment, one sampled data item is removed from the L sampled data items. Obtaining the N sampled data items by removing G sampled data items from the L sampled data items may include: obtaining a fourth data group and a fifth data group from the L sampled data items; obtaining a maximum sampled data item of the fourth data group and a maximum sampled data item of the fifth data group; obtaining a maximum data item between the maximum sampled data item of the fourth data group and the maximum sampled data item of the fifth data group; and determining sampled data items in the L sampled data items except for the maximum data item as the N sampled data items.

A sum of a number of data items in the fourth data group and a number of data items in the fifth data group may be larger than L/2, but smaller than or equal to L. The number of the data items in the fourth data group and the number of the data items in the fifth data group may be same or different. Each of the fourth data group and the fifth data group may include at least one sampled data item.

For example, in one embodiment, L may be 6 and N may be 5. The L sampled data items may be 1 to 6, and the fourth data group and the fifth data group may be obtained from 1 to 6. For example, both the fourth data group and the fifth data group may include two sampled data items. The fourth data group may include 1 and 2, and the fifth data group may include 3 and 4. The maximum sampled data item of the fourth data group may be 2, and the maximum sampled data item of the fifth data group may be 4. The maximum data item between the maximum sampled data item of the fourth data group and the maximum sampled data item of the fifth data group may be 4 by comparing 2 to 4. Then 4 may be removed from 1 to 6, to obtain 5 sampled data items including 1, 2, 3, 5, and 6.

For example, in one embodiment, L may be 8 and N may be 7. The L sampled data items may be 1 to 8, and the fourth data group and the fifth data group may be obtained from 1 to 8. For example, both the fourth data group and the fifth data group may include three sampled data items. The fourth data group may include 1, 2 and 3, and the fifth data group may include 4, 5 and 6. The maximum sampled data item of the fourth data group may be 3, and the maximum sampled data item of the fifth data group may be 6. The maximum data item between the maximum sampled data item of the fourth data group and the maximum sampled data item of the fifth data group may be 6 by comparing 3 to 6. Then 6 may be removed from 1 to 8, to obtain 7 sampled data items including 1, 2, 3, 4, 5, 6, and 8.

In some other embodiments, one sampled data item may be removed from the L sampled data items. Obtaining the N sampled data items by removing G sampled data items from the L sampled data items may include: obtaining a fourth data group and a fifth data group from the L sampled data items; obtaining a minimum sampled data item of the fourth data group and a minimum sampled data item of the fifth data group; obtaining a minimum data item between the minimum sampled data item of the fourth data group and the minimum sampled data item of the fifth data group; and determining sampled data items in the L sampled data items except for the minimum data item as the N sampled data items.

A sum of a number of data items in the fourth data group and a number of data items in the fifth data group may be larger than L/2, and smaller than or equal to L. The number of the data items in the fourth data group and the number of the data items in the fifth data group may be same or different. Each of the fourth data group and the fifth data group may include at least one sampled data item.

For example, in one embodiment, L may be 6 and N may be 5. The L sampled data items may be 1 to 6, and the fourth data group and the fifth data group may be obtained from 1 to 6. For example, both the fourth data group and the fifth data group may include two sampled data items. The fourth data group may include 1 and 2, and the fifth data group may include 3 and 4. The minimum sampled data item of the fourth data group may be 1, and the minimum sampled data item of the fifth data group may be 3. The minimum data item between the minimum sampled data item of the fourth data group and the minimum sampled data item of the fifth data group may be 1 by comparing 1 to 3. Then 1 may be removed from 1 to 6, to obtain 5 sampled data items including 2, 3, 4, 5, and 6.

For example, in one embodiment, L may be 8 and N may be 7. The L sampled data items may be 1 to 8, and the fourth data group and the fifth data group may be obtained from 1 to 8. For example, both the fourth data group and the fifth data group may include three sampled data items. The fourth data group may include 1, 2 and 3, and the fifth data group may include 4, 5 and 6. The minimum sampled data item of the fourth data group may be 1, and the minimum sampled data item of the fifth data group may be 4. The minimum data item between the minimum sampled data item of the fourth data group and the minimum sampled data item of the fifth data group may be 1 by comparing 1 to 4. Then 1 may be removed from 1 to 8, to obtain 7 sampled data items including 2, 3, 4, 5, 6, 7, and 8.

In one embodiment, two sampled data items may be removed from the L sampled data items. Obtaining the N sampled data items by removing G sampled data items from the L sampled data items may include: obtaining a fourth data group and a fifth data group from the L sampled data items; obtaining a maximum sampled data item of the fourth data group and a maximum sampled data item of the fifth data group; obtaining a maximum data item between the maximum sampled data item of the fourth data group and the maximum sampled data item of the fifth data group; obtaining a minimum sampled data item of the fourth data group and a minimum sampled data item of the fifth data group; obtaining a minimum data item between the minimum sampled data item of the fourth data group and the minimum sampled data item of the fifth data group; and determining sampled data items in the L sampled data items except for the maximum data item and the minimum data item as the N sampled data items.

A sum of a number of data items in the fourth data group and a number of data items in the fifth data group may be larger than L/2, and smaller than or equal to L. The number of the data items in the fourth data group and the number of the data items in the fifth data group may be same or different. Each of the fourth data group and the fifth data group may include at least one sampled data item.

For example, in one embodiment, L may be 9 and N may be 7. The L sampled data items may be 1 to 9, and the fourth data group and the fifth data group may be obtained from 1 to 9. For example, both the fourth data group and the fifth data group may include three sampled data items. The fourth data group may include 1, 2 and 3, and the fifth data group may include 4, 5 and 6. The minimum sampled data item of the fourth data group may be 1, and the maximum data item of the fourth data group may be 3. The minimum sampled data item of the fifth data group may be 4, and the maximum sampled data item of the fifth data group may be 6. The minimum data item between the minimum sampled data item of the fourth data group and the minimum sampled data item of the fifth data group may be 1 by comparing 1 to 4. The maximum data item between the maximum sampled data item of the fourth data group and the maximum sampled data item of the fifth data group may be 6 by comparing 3 to 6. Then 1 and 6 may be removed from 1 to 9, to obtain 7 sampled data items including 2, 3, 4, 5, 7, 8, and 9.

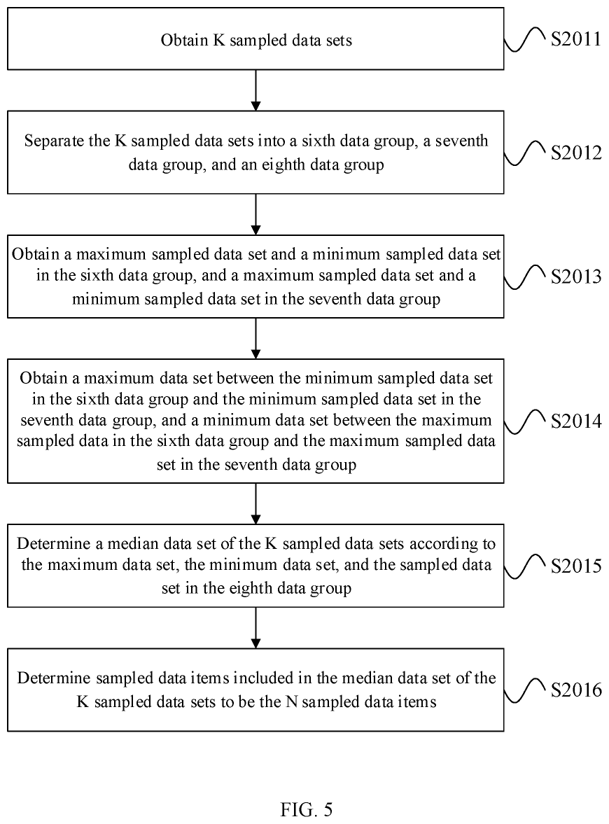

In some other embodiments, as shown in FIG. 5, S201 includes processes S2011 to S2016, as described in more detail below.

At S2011, K sampled data sets are obtained.

In one embodiment, 5 or 7 sampled data sets may be obtained.

In some embodiments, each sampled data set may include 5, 6, 7, or 8 sampled data items.

For example, in one embodiment, 49 sampled data items may be obtained. The first to seventh sampled data items may be used as the first sampled data set. The eighth to fourteenth sampled data items may be used as the second sampled data set. The fifteenth to twenty-first sampled data items may be used as the third sampled data set. The 22^{nd} to 28^{th} sampled data items may be used as the fourth sampled data set. The 29^{th} to 35^{th} sampled data items may be used as the fifth sampled data set. The 36^{th} to 42^{nd} sampled data items may be used as the sixth sampled data set. The 43^{rd} to 49^{th} sampled data items may be used as the seventh sampled data set.

At S2012, the K sampled data sets may be separated into a sixth data group, a seventh data group, and an eighth data group.

The sixth and the seventh data group may each include Q sampled data sets, and the eighth data group may include one sampled data set. K=2×Q+1, where Q is an integer larger than 2.

At S2013, a maximum sampled data set and a minimum sampled data set in the sixth data group, and a maximum sampled data set and a minimum sampled data set in the seventh data group may be obtained.

At S2014, a maximum data set between the minimum sampled data set in the sixth data group and the minimum sampled data set in the seventh data group, and a minimum data set between the maximum sampled data in the sixth data group and the maximum sampled data set in the seventh data group may be obtained.

At S2015, a median data set of the K sampled data sets may be determined according to the maximum data set, the minimum data set, and the sampled data set in the eighth data group.

For description of the processes at S2012-S2015, reference may be made to the above description about S202-S205, which will not be repeated here.

In one embodiment, a comparison between the sampled data sets may be a comparison between the magnitudes of the median sampled data items of the sampled data sets. Correspondingly, a magnitude of a median sampled data item of each sampled data set may be used to represent a magnitude of the sampled data set.

In one embodiment, optionally, the median sampled data item of each sampled data set may be determined according to the process for determining the median sampled data item of the N sampled data items described above.

At S2016, sampled data items included in the median data set of the K sampled data sets may be determined to be the N sampled data items.

In the present embodiment, the median data set of the K sampled data sets may be determined, and then the sampled data items included in the median data set of the K sampled data sets may be determined to be the N sampled data items. That is, a number of the sampled data items in the median data set of the K sampled data sets may be N.

For example, in one embodiment, the 49 sampled data items may be 1-49. 1-7 may be used as the first sampled data set and the median sampled data item may be 4. 8-14 may be used as the second sampled data set and the median sampled data item may be 11. 15-21 may be used as the third sampled data set and the median sampled data item may be 18. 22-28 may be used as the fourth sampled data set and the median sampled data item may be 25. 29-35 may be used as the fifth sampled data set and the median sampled data item may be 32. 36-42 may be used as the sixth sampled data set and the median sampled data item may be 39. 42-49 may be used as the seventh sampled data set and the median sampled data item may be 46. The first, second and third sampled data sets may be used as the sixth data group, the fourth, fifth and sixth sampled data sets may be used as the seventh data group, and the seventh sampled data set may be used as the eighth data group. In the sixth data group, the maximum sampled data set may be determined to be the third sampled data set, the minimum sampled data set may be determined to be the first sampled data set, and the median sampled data set may be determined to be the second sampled data set, by comparing 4, 11, and 18. In the seventh data group, the maximum sampled data set may be determined to be the sixth sampled data set, the minimum sampled data set may be determined to be the fourth sampled data set, and the median sampled data set may be determined to be the fifth sampled data set, by comparing 25, 32, and 39. By comparing 11, 32, and 46, the median value may be determined to be 32. Correspondingly, the median sampled data set among the second sampled data set, the fifth sampled data set, and the seventh sampled data set may be determined to be the fifth sampled data set. Then the median data set may be determined according to the third sampled data set, the fourth sampled data set, and the fifth sampled data set. That is, by comparing 18, 25, and 32, the median sampled data set may be determined to be the fourth sampled data set. Then 22-28 included in the fourth sampled data set may be determined to be the N sampled data items.

In the present embodiment, a plurality of sampled data items may be considered as a sampled data set. Then each sampled data set may be considered as a unit and the median data set among the sampled data sets may be determined. The median data item among the sampled data items in the median data set may be determined. The process for obtaining the median data item may be simple and the efficiency of the median filtering process may be improved.

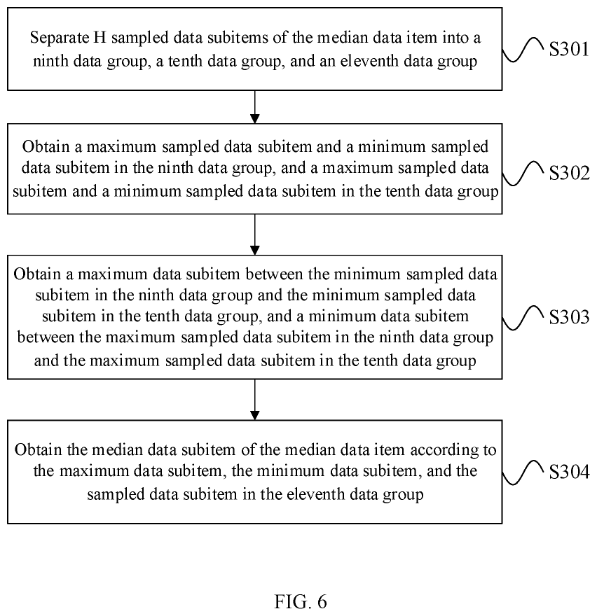

In some other embodiment, the obtained median data item may include H sampled data subitems. Correspondingly, a median sampled data subitem of the H sampled data subitems may need to be obtained. In some embodiments, as shown in FIG. 6, after obtaining the median data item of the N sampled data items, the method further includes processes S301-S304 described in more detail below.

At S301, the H sampled data subitems of the median data item may be separated to a ninth data group, a tenth data group, and an eleventh data group.

Each of the ninth data group and the tenth data group may include T sampled data subitems. The eleventh data group may include one sampled data subitem. H=2×T+1, where T is an integer larger than 2.

At S302, a maximum sampled data subitem and a minimum sampled data subitem in the ninth data group, and a maximum sampled data subitem and a minimum sampled data subitem in the tenth data group, may be determined.

At S303, a maximum data subitem between the minimum sampled data subitem in the ninth data group and the minimum sampled data subitem in the tenth data group, and a minimum data subitem between the maximum sampled data subitem in the ninth data group and the maximum sampled data subitem in the tenth data group, may be determined.

At S304, the median data subitem of the median data item may be determined according to the maximum data subitem, the minimum data subitem, and the sampled data subitem in the eleventh data group.

For the description of detailed process of S301-S304, reference can be made to the description in connection with FIG. 2.

For example, in one embodiment, the sampled data subitems may be 1-343. Every seven sampled data subitems may be used as a sampled data item, and every seven sampled data item may be used as a sampled data set. The seven sampled data sets may be separated into groups to obtain the median sampled data set. Then the seven sampled data items in the median sampled data set may be separated into groups to obtain the median sampled data item. Then the seven sampled data subitems in the median sampled data item may be separated into groups to obtain the median data subitem.

In the present embodiment, the plurality of data items may be grouped in multiple levels (not limited to two or three levels), to obtain the median data item of the plurality of data items. The process for obtaining the median data item may be simple and the efficiency of the median filtering process may be improved.

The present disclosure also provides a computer storage medium. Programming instructions may be stored in the computer storage medium. When the programming instructions are executed, some or all of processes of a data processing method consistent with the disclosure, such as one of the above-described example embodiments, can be implemented.

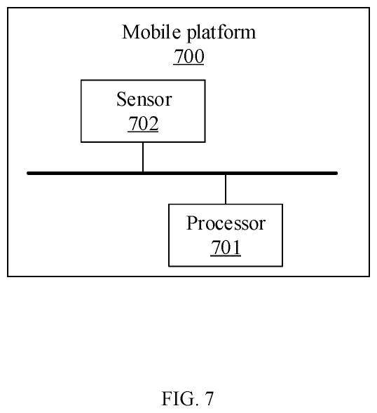

The present disclosure also provides a mobile platform. As illustrated in FIG. 7, in one embodiment, the mobile platform 700 includes a processor 701 and a sensor 702.

The processor 701 may be configured to: obtain N sampled data items from sensor data items output by the sensor 702; separate the N sampled data items to a first data group, a second data group, and a third data group; obtain a maximum sampled data item and a minimum sampled data item in the first data group, and a maximum sampled data item and a minimum sampled data item in the second data group; obtain a maximum data item of the minimum sampled data item in the first data group and the minimum sampled data item in the second data group, and a minimum data item of the maximum sampled data item in the first data group and the maximum sampled data item in the second data group; and obtain a median data item of the N sampled data items according to the maximum data item, the minimum data item, and the sampled data item in the third data group.

Each of the first data group and the second data group may include M sampled data item. And the third data group may include 1 sampled data item. Therefore, N=2×M+1, where M is an integer greater than or equal to 2.

In some embodiments, N may be 5 or 7.

In some embodiments, the processor 701 may be configured to: obtaining L sampled data items from sensor data items output by the sensor 702; and removing G sampled data items from the L sampled data items to obtain the N sampled data items. L=N+G where G is an integer larger than 1.

In some embodiments, the processor 701 may be configured to: obtain a fourth data group and a fifth data group from the L sampled data items, where a sum of a number of data items in the fourth data group and a number of data items in the fifth data group may be larger than L/2, and smaller than or equal to L; obtain a maximum sampled data item of the fourth data group and a maximum sampled data item of the fifth data group; obtain a maximum data item between the maximum sampled data item of the fourth data group and the maximum sampled data item of the fifth data group; and determine sampled data items in the L sampled data items except the maximum data item as the N sampled data items.

In some other embodiments, the processor 701 may be configured to: obtain a fourth data group and a fifth data group from the L sampled data items, where a sum of a number of data items in the fourth data group and a number of data items in the fifth data group may be larger than L/2, and smaller than or equal to L; obtain a minimum sampled data item of the fourth data group and a minimum sampled data item of the fifth data group; obtain a minimum data item between the minimum sampled data item of the fourth data group and the minimum sampled data item of the fifth data group; and determine sampled data items in the L sampled data items except the minimum data item as the N sampled data items.

In some embodiments, N may be 5 and L may be 6. In some other embodiments, N may be 7 and L may be 8.

In some embodiments, L may be 6, and each of the fourth data group and the fifth data group may include two sampled data items.

In some embodiments, L may be 8, and each of the fourth data group and the fifth data group may include three sampled data items.

In some other embodiments, the processor 701 may be configured to: obtain a fourth data group and a fifth data group from the L sampled data items, where a sum of a number of data items in the fourth data group and a number of data items in the fifth data group may be larger than L/2, and smaller than or equal to L; obtain a maximum sampled data item of the fourth data group and a maximum sampled data item of the fifth data group; obtaining a maximum data item between the maximum sampled data item of the fourth data group and the maximum sampled data item of the fifth data group; obtain a minimum sampled data item of the fourth data group and a minimum sampled data item of the fifth data group; obtain a minimum data item between the minimum sampled data item of the fourth data group and the minimum sampled data item of the fifth data group; and determine sampled data items in the L sampled data items except the maximum data item and the minimum data item as the N sampled data items.

In some embodiments, N may be 7 and L may be 9.

In some embodiments, each of the fourth data group and the fifth data group may include three sampled data items.

In some embodiments, the processor 701 may be configured to: obtain K sampled data sets from the sensor data items output by the senor 702; separate the K sampled data sets into a sixth data group, a seventh data group, and an eighth data group, where each of the sixth and the seventh data group may include Q sampled data sets and the eighth data group may include one sampled data set. K=2×Q+1 with Q being an integer larger than 2; obtain a maximum sampled data set and a minimum sampled data set in the sixth data group, and a maximum sampled data set and a minimum sampled data set in the seventh data group; obtain a maximum data set between the minimum sampled data set in the sixth data group and the minimum sampled data set in the seventh data group, and a minimum data set between the maximum sampled data in the sixth data group and the maximum sampled data set in the seventh data group; determine a median data set of the K sampled data sets according to the maximum data set, the minimum data set, and the sampled data set in the eighth data group; and determine sampled data items included in the median data set of the K sampled data sets to be the N sampled data items.

In some embodiments, a comparison between the sampled data sets may be a comparison between the magnitude of the median sampled data items of the sampled data sets.

In some embodiment, the median data item may include H sampled data subitems. Correspondingly, after obtaining the median data item of the N sampled data items, the processor 701 may be further configured to: separate the H sampled data subitems of the median data item into a ninth data group, a tenth data group, and a eleventh data group, where each of the ninth data group and the tenth data group may include T sampled data subitems, and the eleventh data group may include one sampled data subitems with H=2×T+1 with T being an integer larger than 2; obtain a maximum sampled data subitem and a minimum sampled data subitem in the ninth data group, and a maximum sampled data subitem and a minimum sampled data subitem in the tenth data group; obtain a maximum data subitem between the minimum sampled data subitem in the ninth data group and the minimum sampled data subitem in the tenth data group, and a minimum data subitem between the maximum sampled data subitem in the ninth data group and the maximum sampled data subitem in the tenth data group; obtain the median data subitem of the median data item according to the maximum data subitem, the minimum data subitem, and the sampled data subitem in the eleventh data group.

In some embodiments, the processor 701 may be configured to: determine a median data item of the maximum data item, the minimum data item, and the sampled data item in the third data group; and determine the median data item of the maximum data item, the minimum data item, and the sampled data item in the third data group, as the median data item of the N sampled data items.

In some embodiment, the processor 701 may be configured to: determine a median data item of the median data item of the first data group, the median data item of the second data group, and the sampled data item in the third data group; and determine the median data item of the maximum data item, the minimum data item, and the median data item of the median data item of the first data group, the median data item of the second data group, and the sampled data item in the third data group, as the median data item of the N sampled data items.

Optionally, in one embodiment, the maximum data item may be the last data item after sorting according to a preset order, and the minimum data item may be the first data item after sorting according to the preset order.

Optionally, in another embodiment, the maximum data item may be the first data item after sorting according to a preset order, and the minimum data item may be the last data item after sorting according to the preset order.

In some embodiments, the sensor data items may include: image data items, audio data items, magnetic field strength, temperature, humidity, position information, displacement, attitude angle, acceleration, and/or velocity.

In some embodiments, the mobile platform 700 may further include a memory (not shown in the figures). The memory may be configured to store program codes. When the program codes are executed, the mobile platform 700 may be configured to achieve the technical implementation of various embodiments of the present disclosure.

The mobile platform consistent with the disclosure can implement a technical solution consistent with the disclosure, such as one of those described above. The principle and technical effect are similar, and thus are not repeated here.

All or part of the above embodiments may be implemented by a program instructing relevant hardware. The above program can be stored in a computer readable storage medium. When the program is executed, the above embodiments may be executed. The storage medium include: a read-only memory (ROM), a random access memory (RAM), a magnetic disc, an optical disk, or another medium that can store program codes.

In this disclosure, terms such as “first” and “second” are only used to distinguish one entity or operation from another entity or operation, and do not necessarily require or imply existence of any such relationship or sequence among these entities or operations. The terms “include,” “comprise” or any other variants thereof are intended to cover non-exclusive inclusion, so that a process, method, article, or device including a series of elements not only includes those elements, but also includes other elements not explicitly listed, or also includes elements inherent to such process, method, article, or device. If there are no more restrictions, the element associated with “including a . . . ” does not exclude the existence of other identical elements in the process, method, article, or device that includes the element.

Other embodiments of the disclosure will be apparent to those skilled in the art from consideration of the specification and practice of the embodiments disclosed herein. It is intended that the specification and examples be considered as examples only and not to limit the scope of the disclosure, with a true scope and spirit of the invention being indicated by the following claims.

What is claimed is:

1. A data processing method comprising:
obtaining N sampled data items from a sensor of a mobile platform;
separating the N sampled data items into a first data group, a second data group, and a third data group, each of the first data group and the second data group including M sampled data items, the third data group including one sampled data items, M being an integer greater than or equal to 2, and N=2×M+1; and
obtaining a median data item of the N sampled data items according to:
a larger one of a minimum sampled data item in the first data group and a minimum sampled data item in the second data group,
a smaller one of a maximum sampled data item in the first data group and a maximum sampled data item in the second data group, and
the one sampled data item in the third data group.

2. The method according to claim 1, wherein obtaining the N sampled data items includes:
obtaining L sampled data items; and
removing G sampled data items from the L sampled data items to obtain the N sampled data items, G being an integer larger than 1, and L=N+G.

3. The method according to claim 2, wherein removing the G sampled data items from the L sampled data items to obtain the N sampled data items includes:
obtaining a fourth data group and a fifth data group from the L sampled data items, a sum of a number of data items in the fourth data group and a number of data items in the fifth data group being larger than L/2 and smaller than or equal to L; and
obtaining the N sampled data items based on the fourth data group and the fifth data group, including:
removing a larger one of a maximum sampled data item in the fourth data group and a maximum sampled data item in the fifth data group from the L sampled data items to obtain the N sampled data items; or
removing a smaller one of a minimum sampled data item in the fourth data group and a minimum sampled data item in the fifth data group from the L sampled data items to obtain the N sampled data items.

4. The method according to claim 2, wherein removing the G sampled data items from the L sampled data items to obtain the N sampled data items includes:
obtaining a fourth data group and a fifth data group from the L sampled data items, a sum of a number of data items in the fourth data group and a number of data items in the fifth data group being larger than L/2 and smaller than or equal to L; and
removing a larger one of a maximum sampled data item in the fourth data group and a maximum sampled data item in the fifth data group and a smaller one of a minimum sampled data item in the fourth data group and a minimum sampled data item in the fifth data group from the L sampled data items to obtain the N sampled data items.

5. The method according to claim 1, wherein obtaining the N sampled data items includes:
obtaining K sampled data sets;
separating the K sampled data sets into a fourth data group, a fifth data group, and a sixth data group, each of the fourth data group and the fifth data group including Q sampled data sets, the sixth data group including one sampled data set, Q being an integer larger than 2, and K=2×Q+1;
determining a median data set of the K sampled data sets according to:
a larger one of a minimum sampled data set in the fourth data group and a minimum sampled data set in the fifth data group,
a smaller one of a maximum sampled data in the fourth data group and a maximum sampled data set in the fifth data group, and
the one sampled data set in the sixth data group; and
obtaining the N sampled data item according to sampled data items included in the median data set.

6. The method according to claim 5, wherein a comparison between two sampled data sets includes a comparison between a magnitude of a median sampled data item in one of the two sampled data sets and a magnitude of a median sampled data item in another one of the two sampled data sets.

7. The method according to claim 1, further comprising:
separating H sampled data subitems of the median data item into a fourth data group, a fifth data group, and a sixth data group, each of the fourth data group and the fifth data group including T sampled data subitems, the sixth data group including one sampled data subitem, T being an integer larger than 2, and H=2×T+1; and
obtaining a median data subitem of the median data item according to:
a larger one of a minimum sampled data subitem in the fourth data group and a minimum sampled data subitem in the fifth data group,
a smaller one of a maximum sampled data subitem in the fourth data group and a maximum sampled data subitem in the fifth data group, and
the one sampled data subitem in the sixth data group.

8. The method according to claim 1, wherein obtaining the median data item of the N sampled data items includes determining the median data item of the N sampled data items to be a median one of:
the larger one of the minimum sampled data item in the first data group and the minimum sampled data item in the second data group,
the smaller one of the maximum sampled data item in the first data group and the maximum sampled data item in the second data group, and
the one sampled data item in the third data group.

9. The method according to claim 1, wherein obtaining the median data item of the N sampled data items includes determining the median data item of the N sampled data items to be a median one of:
the larger one of the minimum sampled data item in the first data group and the minimum sampled data item in the second data group,
the smaller one of the maximum sampled data item in the first data group and the maximum sampled data item in the second data group, and
a median one of:
a median sampled data item in the first data group,
a median sampled data item in the second data group, and
the one sampled data item in the third data group.

10. The method according to claim 1, further comprising, for each of the first data group and the second data group:
sorting the M sampled data items according to a first preset order to obtain M sorted sampled data items in the first preset order, and determining a first one of the M sorted sampled data items in the first preset order as the minimum sampled data item and a last one of the M sorted sampled data items in the first preset order as the maximum sampled data item; or
sorting the M sampled data items according to a second preset order to obtain M sorted sampled data items in the second preset order, and determining a first one of the M sorted sampled data items in the second preset order as the maximum sampled data item and a last one of the M sorted sampled data items in the second preset order as the minimum sampled data item.

11. A mobile platform comprising:
a sensor; and
a processor configured to:
obtain N sampled data items from the sensor;
separate the N sampled data items into a first data group, a second data group, and a third data group, each of the first data group and the second data group including M sampled data items, the third data group including one sampled data items, M being an integer greater than or equal to 2, and N=2×M+1; and
obtain a median data item of the N sampled data items according to:
a larger one of a minimum sampled data item in the first data group and a minimum sampled data item in the second data group,
a smaller one of a maximum sampled data item in the first data group and a maximum sampled data item in the second data group, and
the one sampled data item in the third data group.

12. The mobile platform according to claim 11, wherein the processor is further configured to:
obtain L sampled data items; and
remove G sampled data items from the L sampled data items to obtain the N sampled data items, G being an integer larger than 1, and L=N+G.

13. The mobile platform according to claim 12, wherein the processor is further configured to:
obtain a fourth data group and a fifth data group from the L sampled data items, a sum of a number of data items in the fourth data group and a number of data items in the fifth data group being larger than L/2 and smaller than or equal to L; and
obtain the N sampled data items based on the fourth data group and the fifth data group, including:
removing a larger one of a maximum sampled data item in the fourth data group and a maximum sampled data item in the fifth data group from the L sampled data items to obtain the N sampled data items; or
removing a smaller one of a minimum sampled data item in the fourth data group and a minimum sampled data item in the fifth data group from the L sampled data items to obtain the N sampled data items.

14. The mobile platform according to claim 12, wherein the processor is further configured to:
obtain a fourth data group and a fifth data group from the L sampled data items, a sum of a number of data items in the fourth data group and a number of data items in the fifth data group being larger than L/2 and smaller than or equal to L; and
remove a larger one of a maximum sampled data item in the fourth data group and a maximum sampled data item in the fifth data group and a smaller one of a minimum sampled data item in the fourth data group and a minimum sampled data item in the fifth data group from the L sampled data items to obtain the N sampled data items.

15. The mobile platform according to claim 11, wherein the processor is further configured to:
obtain K sampled data sets;
separate the K sampled data sets into a fourth data group, a fifth data group, and a sixth data group, each of the fourth data group and the fifth data group including Q sampled data sets, the sixth data group including one sampled data set, Q being an integer larger than 2, and K=2×Q+1;
determine a median data set of the K sampled data sets according to:
a larger one of a minimum sampled data set in the fourth data group and a minimum sampled data set in the fifth data group,
a smaller one of a maximum sampled data in the fourth data group and a maximum sampled data set in the fifth data group, and
the one sampled data set in the sixth data group; and
obtain the N sampled data item according to sampled data items included in the median data set.

16. The mobile platform according to claim 15, wherein a comparison between two sampled data sets includes a comparison between a magnitude of a median sampled data item in one of the two sampled data sets and a magnitude of a median sampled data item in another one of the two sampled data sets.

17. The mobile platform according to claim 11, wherein the processor is further configured to:
separate H sampled data subitems of the median data item into a fourth data group, a fifth data group, and a sixth data group, each of the fourth data group and the fifth data group including T sampled data subitems, the sixth data group including one sampled data subitem, T being an integer larger than 2, and H=2×T+1; and
obtain a median data subitem of the median data item according to:
a larger one of a minimum sampled data subitem in the fourth data group and a minimum sampled data subitem in the fifth data group,
a smaller one of a maximum sampled data subitem in the fourth data group and a maximum sampled data subitem in the fifth data group, and
the one sampled data subitem in the sixth data group.

18. The mobile platform according to claim 11, wherein the processor is further configured to determine the median data item of the N sampled data items to be a median one of:
the larger one of the minimum sampled data item in the first data group and the minimum sampled data item in the second data group,
the smaller one of the maximum sampled data item in the first data group and the maximum sampled data item in the second data group, and
the one sampled data item in the third data group.

19. The mobile platform according to claim 11, wherein the processor is further configured to determine the median data item of the N sampled data items to be a median one of:
the larger one of the minimum sampled data item in the first data group and the minimum sampled data item in the second data group,
the smaller one of the maximum sampled data item in the first data group and the maximum sampled data item in the second data group, and
a median one of:
a median sampled data item in the first data group,
a median sampled data item in the second data group, and
the one sampled data item in the third data group.

20. The mobile platform according to claim 11, wherein the processor is further configured to, for each of the first data group and the second data group:
sort the M sampled data items according to a first preset order to obtain M sorted sampled data items in the first preset order, and determine a first one of the M sorted sampled data items in the first preset order as the minimum sampled data item and a last one of the M sorted sampled data items in the first preset order as the maximum sampled data item; or
sort the M sampled data items according to a second preset order to obtain M sorted sampled data items in the second preset order, and determine a first one of the M sorted sampled data items in the second preset order as the maximum sampled data item and a last one of the M sorted sampled data items in the second preset order as the minimum sampled data item.
